(19) United States
(12) Patent Application Publication
(10) Pub. No.: US 2009/0102749 A1
(43) Pub. Date: Apr. 23, 2009

(54) DISPLAY DEVICE HAVING DIGITAL AND ANALOG SUBPIXELS

(76) Inventor: Kazuyoshi Kawabe, Yokohama (JP)

Correspondence Address: J. Lanny Tucker;Patent Legal Staff, Eastman Kodak Company, 343 State Street, Rochester, NY, 14650-2201, US

(21) Appl. No.: 12/248,224

(22) Filed: Oct. 9, 2008

(30) Foreign Application Priority Data
Oct. 18, 2007 (JP) 2007-270837

(51) Int. Cl. G09G 3/30

(52) U.S. Cl. 345/45

(57) ABSTRACT

An organic EL display including a plurality of digital data lines; a plurality of analog data lines; a plurality of pixels arranged in a matrix, each pixel having a digital sub-pixel connected to one of the plurality of digital data lines and an analog sub-pixel connected to one of the plurality of analog data lines; and a plurality of hybrid data drivers, each connected to the respective digital data line and the respective analog data line, for receiving input data, dividing the input data into digital data and analog data, and supplying digital data to the respective digital data line and analog data to the respective analog data line

### CROSS-REFERENCE TO RELATED APPLICATION

This application claims priority of Japanese Patent Application No. 2007-270837 filed Oct. 18, 2007 which is incorporated herein by reference in its entirety.

### FIELD OF THE INVENTION

The present invention relates to a display device having pixels arranged in a matrix.

### BACKGROUND OF THE INVENTION

As organic EL displays are self-luminous so that a high contrast and a fast response can be achieved, the organic EL displays are suited for applications dealing with moving images such as TVs, which display natural images and the like. In general, multiple gray scales in organic EL elements are achieved by using control elements such as transistors to drive the organic EL elements by a constant current or a constant voltage, or by changing the light emission durations of the organic EL elements.

When the organic EL elements are driven by a constant current, the electric power consumption of transistors increases because the transistors are used in saturation regions. Therefore, the constant current driving is not suited for reducing electrical power consumption. However, when the organic EL elements are driven by a constant voltage, the power consumption of transistors can be reduced because the transistors are used in linear regions.

### SUMMARY OF THE INVENTION

In digital driving, in which a constant voltage is applied, each pixel can only achieve one-bit gray scale performance. Therefore, when sub frames are used to achieve multiple gray scales, a high speed operation is required because multiple accesses to a single pixel are required for one frame period. However, in particular, when the number of pixels increases to achieve high definition display, data for sub frames must be written onto each pixel and multiple gray scales are difficult to achieve. On the other hand, even when a plurality of sub-pixels with different emission intensities are employed and digitally driven, bit data is required to be rapidly written onto the corresponding plurality of sub-pixels and high definition display is difficult to achieve.

Moreover, in either of these methods of digital driving, as the number of accesses to pixels increases when higher definition display and more multiple gray scales are required, the electric power consumption of drive circuits also increases. Specifically, the larger the display size is, the higher the electric power consumption of the drive circuits becomes. Attempts to reduce power consumption are further impeded as the frequency increases in conjunction with higher definition display.

In one aspect of the present invention, there is provided a display device including a plurality of pixels arranged in a matrix, wherein each pixel includes a plurality of sub-pixels, and the plurality of sub-pixels include a digital pixel driven by digital data and an analog pixel driven by analog data.

In another aspect of the present invention, preferably, input data is input into a hybrid data driver, and the hybrid data driver divides the input data into two pieces of data, supplies one piece of data as digital data to the digital pixel via a digital data line, and supplies the other piece of data as analog data to the analog pixel via an analog data line.

In another aspect of the present invention, the digital pixel preferably includes a static memory for storing the digital data supplied from the digital data line.

In another aspect of the invention, preferably, the digital pixel and the analog pixel are arranged in respective columns, the digital data line is provided along the column for the digital pixel, and the analog data line is provided along the column for the analog pixel.

In another aspect of the invention, preferably, the input data is digital data, the hybrid data driver includes an output register for storing the input data, and a digital processor and an analog processor for processing the input date stored in the output register, the digital processor supplies digital data based on the one piece of data of the input data to the digital data line, and the analog processor supplies analog data based on the other piece of data of the input data to the analog data line.

In another aspect of the present invention, preferably, the input data is supplied to the output register via a data register, and the data register sequentially supplies the input data for the digital pixel and the input data for the analog pixel to the output register.

With the present invention, as digital pixels can be used to achieve digital display, the electric power consumption can be reduced, while as analog pixels can be used to achieve analog display, display with multiple gray scales can be effectively achieved.

### BRIEF DESCRIPTION OF THE DRAWINGS

The accompanying drawings, which are incorporated in and constitute a part of the specification, illustrate an embodiment of the invention and, together with the description, serve to explain the principles of the invention, in which:

FIG. 1 is a diagram showing an example of a structure of a unit pixel including three sub-pixels;

FIG. 2 is a diagram showing the I-V characteristics of sub-pixels and a transistor;

FIG. 3 is a diagram showing an example of another structure of a unit pixel including three sub-pixels;

FIG. 4 is a diagram showing the entire structure of a display device;

FIG. 5 is a diagram showing a data update;

FIG. 6 is a diagram showing an example of a structure of a hybrid data driver; and

FIG. 7 is a diagram showing an example of a structure for controlling sub-pixels.

### DETAILED DESCRIPTION OF THE INVENTION

Preferred embodiments of the present invention will be described below with reference to the accompanied drawings.

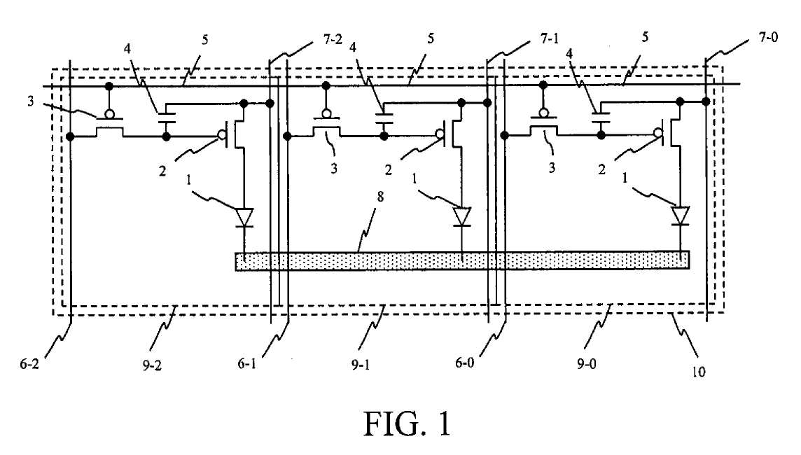

FIG. 1 shows a structure of a unit pixel 10 having three sub-pixels 9 (9-0, 9-1, and 9-2) representing colors such as RGB. Other sub-pixel structures using, for example, four pixels for RGBW can be employed to provide a unit pixel 10.

Each sub-pixel 9 includes a p-channel drive transistor 2 serially connected to an organic EL element 1, a p-channel gate transistor 3, and a storage capacitor 4. The source terminal of the drive transistor 2 is connected to a power supply line 7, while the drain terminal thereof is connected to the anode of the organic EL element 1. The cathode of the organic EL element 1 is connected to a cathode electrode 8 which is shared with all the sub-pixels in the unit pixel and to which VSS is applied. In addition, the source terminal of the gate transistor 3 having the gate terminal connected to a gate line 5 and the drain terminal connected to a data line 6 is connected to one end of the storage capacitor 4 having the other end connected to the power supply line 7. The source terminal is also connected to the gate terminal of the drive transistor 2.

In each sub-pixel 9 as described above, when the gate line 5 is selected (or set to Low), a signal provided to the data line 6 is written to the storage capacitor 4. And then, after the drive transistor 2 is turned on, a current flows through the organic EL element 1, and the organic EL element 1 emits light. At this moment, the relationship between the gate voltage and the drain voltage of the drive transistor 2 determines whether the drive transistor 2 operates in a saturation region (constant current driving) or in a linear region (constant voltage driving). When the drive transistor 2 operates in the saturation region, the analog control of the drive transistor 2 can be achieved because the signals provided to the data line 6 change the current flowing through the organic EL element 1. On the other hand, when the drive transistor 2 operates in the linear region, multiple gray scales using sub frames are required because the drive transistor 2 is only controlled by the on-off operations of the drive transistor 2.

First and second sub-pixels 9-2 and 9-1 forming the unit pixel 10 shown in FIG. 1 are connected to respective power supply lines 7-2 and 7-1. Each power supply line 7-2 and 7-1 is supplied with a first power supply potential VDD1, and operated by constant voltage digital driving (digital sub-pixels). It should be noted that the first and second sub-pixels have different light emission area sizes, with the ratios thereof being as follows: sub-pixel 9-2:sub-pixel 9-1=2:1. Alternatively, the light emission duration of the sub-pixels 9-2 and 9-1 can be controlled by, for example, writing off data onto the sub-pixel 9-1 half the duration after on-data is written onto the sub-pixel 9-1 to achieve the following emission intensity ratio: sub-pixel 9-2:sub-pixel 9-1=2:1. Further alternatively, different first power supply potentials VDD1-2, VDD1-1 can be applied to the power supply lines 7-2 and 7-1 respectively to achieve the following emission intensity ratio: sub-pixel 9-2:sub-pixel 9-1=2:1. In any event, the emission intensity ratio of the first sub-pixel 9-2 and the second sub-pixel 9-1 is 2:1.

A third sub-pixel 9-0 is operated by constant current driving (analog sub-pixel) because a second power supply potential VDD2 is applied to a power supply line 7-0. That is, analog signals supplied to the data line 6-0 are applied to the gate terminal of the drive transistor 2, and the current flowing through the organic EL element 1 is controlled.

For example, when six-bit digital video data is externally input, first the upper two bits of the digital video data are written onto the first and second sub-pixels 9-2 and 9-1, respectively. Next, the lower four bits of the digital video data are converted into analog signals and written onto the third sub-pixel 9-0. Thus, a six-bit gray scale display is achieved using three sub-pixels 9.

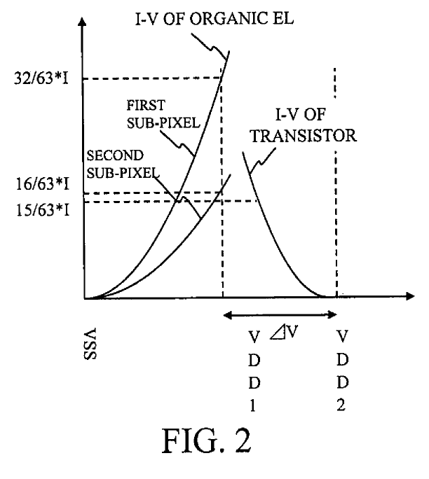

To achieve such a gray scale control as described above, the ratio of the emission intensities (maximum values) of the first, second, and third sub-pixels can be 32:16:15. As the emission intensity of the third sub-pixel is determined by the current generated by the drive transistor 2, the operating point of the transistor can be preferably set as shown in FIG. 2.

FIG. 2 shows the current-voltage curves (I-V) of the organic EL elements 1 constituting the three sub-pixels and the I-V curve of the drive transistor of the third sub-pixel along with the first power supply potential (digital power supply potential) and the second power supply potential (analog power supply potential). However, the I-V curves of the drive transistors 2 of the first and second sub-pixels are omitted. As the I-V curves of the organic EL elements 1 vary with the light emission area sizes, with the I-V curve of the organic EL element 1 of the first sub-pixel, twice the current amount can be generated for the same digital power supply potential in comparison with the I-V curve of the organic EL element 1 of the second sub-pixel. In FIG. 2, the light emission area size of the organic EL element 1 of the third sub-pixel is the same as that of the organic EL element 1 of the second sub-pixel to equalize the current densities of the respective sub-pixels. However, the sub-pixels can have different light emission area sizes.

Multiple gray scales in the third sub-pixel can be achieved by constant current driving, by setting the analog power supply potential VDD2 higher than the digital power supply potential VDD1 as shown in FIG. 2 so that the drive transistor 2 of the third sub-pixel 9-0 can operate in the saturation region when the organic EL element 1 of the third sub-pixel is driven.

As described above, the electric power consumption of the unit pixel 10 including the first, second, and third sub-pixels 9-2, 9-1, and 9-0, the emission intensity ratio of which is 32:16:15, can be calculated with reference to FIG. 2 as follows. Provided that VSS=0, the electric power consumptions of the first and second sub-pixels are (32/63)×I×VDD1 and (16/63)×I×VDD1, respectively, resulting in a total electric power consumption of (48/63)×I×VDD1, wherein I is the current amount required for the unit pixel 10.

On the other hand, as the electric power consumption (maximum value) of the third sub-pixel is (15/63)×I×VDD2, the electric power consumption Ph of the unit pixel 10 is Ph=I×VDD1+(15/63)×I×ΔV, provided that ΔV=VDD2−VDD1.

If all the sub-pixels are controlled by constant current driving, the electric power consumption Pa of the unit pixel 10 is Pa=I×VDD2, while if all the sub-pixels are controlled by constant voltage driving, the electric power consumption Pd of the unit pixel 10 is Pd=I×VDD1. Therefore, Pa, Pd, and Ph reduce to Pa=2×I×VDD1, Pd=I×VDD1, and Ph=(78/63)×I×VDD1=1.24×Pd, provided that ΔV=VDD (VDD2=2×VDD1). Thus, it can be understood that the electric power consumption Ph of a hybrid pixel according to an embodiment of the present invention, in which digital sub-pixels and analog sub-pixels are combined, increases by at most 24% in comparison with the electric power consumption Pd of a pixel in which all sub-pixels are driven by digital data.

In a hybrid pixel including digital sub-pixels and analog sub-pixels as shown in FIG. 1, multiple gray scales are achieved using analog signals on some sub-pixels. Therefore, multiple gray scales can be easily achieved without employing a large number of sub-pixels, and higher definition display can be also effectively achieved. The electric power consumption of the hybrid pixel is higher than that of a pixel in which all sub-pixels are driven by a constant voltage, while the electric power consumption of the hybrid pixel can be lower than that of a pixel in which all sub-pixels are driven by a constant current. In particular, high frequency driving using sub frames and the like is not necessary for high definition display and multiple gray scales. Thus, the electric power consumption of the drive circuits can be lower than that of conventional digital drive circuits. Although applying digital driving to the sub-pixels corresponding to the upper bits can effectively reduce the electric power consumption as describe above, analog driving and digital driving can be applied to the sub-pixels corresponding to the upper bits and the sub-pixels corresponding to the lower bits, respectively.

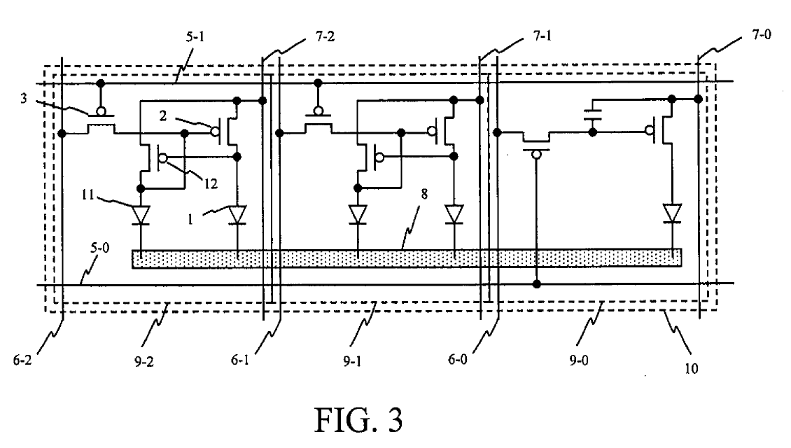

Employing a greater number of sub-pixels provides some advantages, such that multiple gray scales can be achieved more easily and a lower electric power consumption of analog sub-pixels for lower bits which are controlled by a constant current can be achieved. On the other hand, the electric power consumption can be also reduced by employing sub-pixels each of which has a static memory as shown in FIG. 3.

FIG. 3 shows an example of a structure of a unit pixel 10 in which each of first and second sub-pixels has a static memory The descriptions regarding the light emission area sizes and the emission intensities will not be repeated because these are the same as in the configuration shown in FIG. 1. This embodiment differs from the embodiment shown in FIG. 1 in that the first and second sub-pixels do not have storage capacitors 4. Instead, second organic EL elements 11 and second drive transistors 12 are employed in these sub-pixels to enable static operations of these sub-pixels.

That is, the anode of the second organic EL element 11 having the cathode connected to a cathode electrode 8 shared with all the sub-pixels in the unit pixel and applied with VSS is connected to the drain terminal of the second drive transistor 12, the gate terminal of a first drive transistor 2, and the source terminal of a gate transistor 3. The source terminal of the second drive transistor 12 is connected to a power supply line 7.

First and second sub-pixels 9-2 and 9-1 are controlled by a first gate line 5-1, while a third sub-pixel 9-0 is controlled by a second gate line 5-0.

When the gate line 5-1 is selected and High or Low digital data is supplied to the data lines 6-2 and 6-1, the operations of the sub-pixels are determined according to the supplied data.

For example, when Low data is supplied to the gate line 5-1 and the gate line 5-1 is selected, the gate transistors 3 are turned on. Here, when Low data is supplied to the data lines 6-2 and 6-1, and the second transistors are turned on, a current flows through the first organic elements 1 so that the elements emit light. Also, the gate potentials of the second transistors 12 are increased to the first power supply potential VDD1, and the second drive transistors 12 are turned off. As the gate potentials of the first drive transistors 2 are kept at the cathode potential by the second organic EL elements 11, the same condition is maintained after the gate line 5-1 is deselected.

Similarly, when High data is supplied to the data lines 6-2 and 6-1, when the first drive transistors 2 are turned off and the potentials of the first organic EL elements 1 are decreased to the cathode potential, the second drive transistors 12 are turned on and a current flows through the second organic EL elements 11. As the second organic EL elements 11 are shaded using metal wiring, black matrix and the like, light emitted from the second organic EL elements are not released outside even when a current flows through the elements so that the contrasts of the sub-pixels are not reduced. As the gate potentials of the first drive transistors 2 are increased to the first power supply potential VDD1 by the second organic EL elements 11, the same condition is maintained after the gate line 5-1 is deselected.

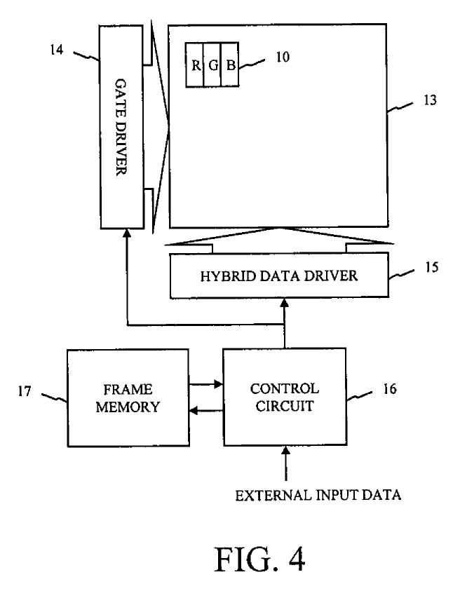

As described above, in the pixel employing a static memory, video data written once is maintained even if a refresh operation is not executed, unlike in the pixel as shown in FIG. 1, in which a storage capacitor is used to hold data for a certain period of time. With this technical feature, the electric power consumptions of the drive circuits can be reduced. This feature is preferably achieved in a display system as shown in FIG. 4.

The display system as shown in FIG. 4 includes a display array 13 in which unit pixels 10 for RGB are arranged in an array, a gate driver 14 for supplying selection signals to the gate lines 5, a hybrid data driver 15 for supplying digital signals and analog signals to the data lines 6, a control circuit 16, and a frame memory 17.

External input data is input into the control circuit 16, and temporarily stored in the frame memory 17. When video data for the next frame is input, the control circuit 16 reads out the video data for the previous frame stored in the frame memory 17 and compares the video data with each other, and performs a control operation so as to only update the lines having some variations between the video data.

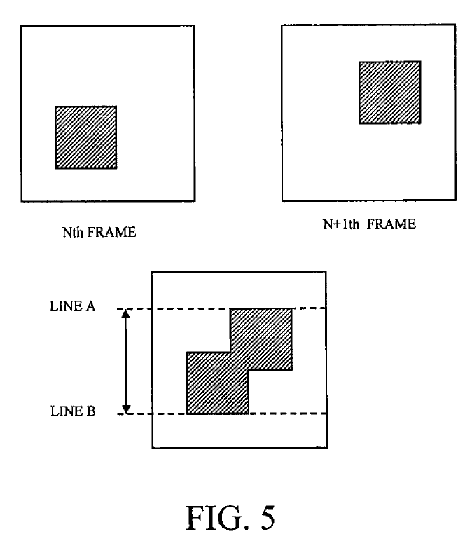

For example, when a rectangular area indicated by oblique lines moves from bottom left to top right from one frame to another as shown in FIG. 5, the area in which all bit data must be updated is limited to the area between the line A and the line B. In general, the gate driver 14 sequentially selects the gate lines from top down. However, as there is no variation of the video data between the top line and the line A, the control circuit 16 does not transmit the upper two bit data to the hybrid data driver 15, and transmits only the lower four bit data to the hybrid data driver 15. The gate driver 14 is controlled by the control circuit 16 so as to select not the first gate line 5-1 for the first and second sub-pixels but only the second gate line 5-0 for controlling the writing operations to the third sub-pixel. Meanwhile, the hybrid data driver 15 applies DA conversion to the digital data for the lower four bits, and outputs the converted data to the data line 6-0. Therefore, the analog data for the lower four bits is written onto the third sub-pixel.

As all data between the line A and the line B is required to be updated, the control circuit 16 transmits the data for the upper two bits and the lower four bits to the hybrid data driver 15, and controls the gate driver 14 to select the first and second gate lines 5-1 and 5-0. The gate driver 14 first selects the first gate line 5-1, while the hybrid data driver 15 outputs each piece of the digital data for the upper two bits to the data lines 6-2 and 6-1, respectively.

When the writing operations to the first and second sub-pixels complete, the first gate line 5-1 is deselected and the second gate line 5-0 is selected. At this timing, the hybrid data driver 15 outputs the DA converted data for the lower four bits to the data line 6-0, and then the analog data is written onto the third sub-pixels. When this writing operation completes, the second gate line 5-0 is deselected. As there is no variation of the video data between the line B and the bottom line, the control with the same procedure as for the lines between the top line and the line A is applied to the lines between the line B and the bottom line.

As described above, unlike the unit pixel shown in FIG. 1, which must be constantly refreshed, the pixel shown in FIG. 3 includes a static memory. Therefore, the load on the gate driver 14 for driving the gate line 5-1, and the load on the hybrid data driver 15 for driving the data lines 6-2 and 6-1 can be alleviated, and the electric power consumption can be reduced. In particular, when static images, in which the video data does not change, are displayed on a large-screen high-definition display panel, the electric power consumption can be reduced to a large degree. Also, the refresh rate for the analog writing of the lower four bit data can be set lower than a normal refresh rate if the control circuit 16 detects no video data variation. For example, if the normal refresh rate is 60 Hz, the refresh rate for the analog writing can be set to 30 Hz to thereby achieve further reduction in power consumption.

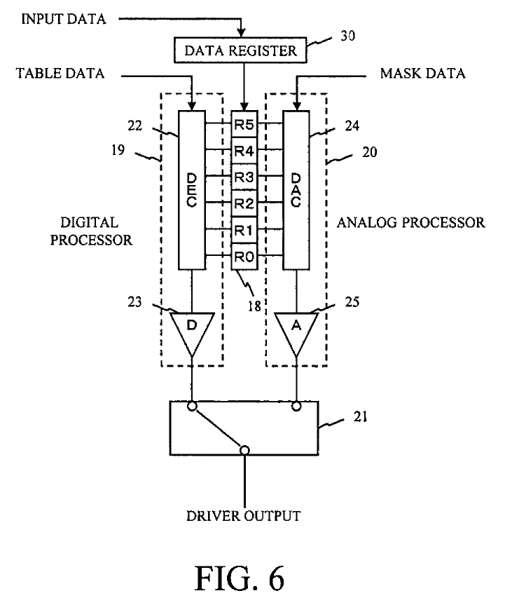

FIG. 6 shows a structure of an output of the hybrid data driver 15. The hybrid data driver 15 practically has as many circuits shown in FIG. 6 as output terminals. In this circuit, each unit of pixel data transmitted from the control circuit 16 is sequentially stored in a data register 30, and then the stored pixel data is collectively stored in an output register 18. After one line of data is stored in the output register 18, the digital data stored in the output register 18 is supplied to a digital processor 19 and an analog processor 20. In the digital processor 19, a decoder 22 converts the digital data into one-bit data, and a digital buffer 23 buffers the one-bit data. On the other hand, in the analog processor 20, a DA converter 24 converts the digital data into analog data, and an analog buffer 25 buffers the analog data. A selector 21 switches the outputs of the digital processor and the analog processor to output the respective data.

In order to write the upper two bit data onto the first and second sub-pixels, the selector 21 connects the driver output with the digital processor 19, and then the upper two bit data of the six bit data stored in the output register 18 is sequentially fetched via the decoder 22, buffered by the digital buffer 23, and output via the driver output. On the other hand, in order to write the analog data for the lower four bits onto the third sub-pixel, the selector 21 connects the driver output with the analog processor 20, and then the lower four bit data is converted into analog data by the DA converter 24, buffered by the analog buffer 25, and output via the driver output.

The decoder 22 of the digital processor 19 can fetch any bits of the six bit data stored in the output register 18. Alternatively, the decoder 22 can be used as a 64-input-1-output decoder for outputting one piece of data selected from a 64 bit table data based on the six bit data stored in the output register 18.

The DA converter 24 of the analog processor 20 can also mask any bits of the six bit data stored in the output register 18 to convert the masked data. For example, in order to apply a DA conversion only to the lower four bit data, the upper two bit data can be masked by setting “001111” to the mask data and performing an AND operation of the data in the output register and the mask data so that an analog conversion of the lower four bit data can be achieved without the influence of the upper two bit data. With this arrangement, even if there are, for example, three digital sub-pixels in a unit pixel, the table data in the digital processor 19 can be modified to output the upper three bit data without the influence of the lower three bit data. Also, setting “000111” to the mask data in the analog processor 20 can achieve a DA conversion without the influence of the upper three bit data in the output register. As such, flexible responses can be ensured in this arrangement.

Data transfer operations of the upper bits and the lower bits can be separately performed. For example, a line memory is employed in the control circuit 16 to store one line of external input data, while the upper two bit data is transferred to the hybrid data driver 15 in advance. The selector 21 then connects the driver output with the digital processor 19, the decoder 22 ignores the lower four bit data and fetches only the upper two bit data, and the data is output via the driver output. Next, the control circuit 16 transfers the lower four bit data of the one line of external input data to the hybrid data driver 15. Meanwhile, the selector 21 connects the driver output with the analog processor 20, the upper two bit data is masked, a DA conversion is applied to the data, and the converted analog data is output via the driver output.

Transferring the upper bit data and the lower bit data separately in two stages as described above makes it possible to achieve, at maximum, digital output of the upper six bit data and analog output of the lower six bit data. Therefore, the gray scale display of a total of 12 bits can be achieved. In an arrangement employing seven sub-pixels, including six digital sub-pixels and one analog sub-pixel, the upper six bit data is written onto the respective six digital sub-pixels, while the lower six bit data is written onto the analog sub-pixel. Therefore, the potential advantages of such a two-stage transfer can be fully realized.

In the structure as shown in FIG. 6, gray scales of up to 12 bits can be produced while still providing a relatively small analog processor, because the analog processor handles at most six bits. Consequently, the area required for IC chips can be smaller compared to structures for achieving multiple gray scales using a large analog processor for 8 bits, 10 bits and the like. As such, the structure according to the present invention can be realized at lower cost.

In addition, although the output register 18 is shared with the digital processor and the analog processor in FIG. 6, respective output registers can be provided for the digital processor and the analog processor. Also, respective driver outputs can be provided for the digital output and the analog output.

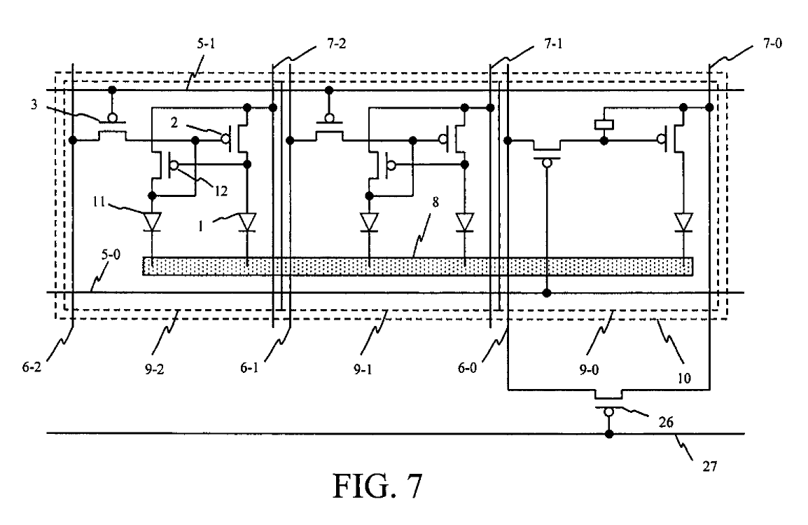

Furthermore, for static images, such as menu screen and text display which do not require multi-bit display, writing operations to sub-pixels with analog driving can be omitted. In that case, preferably, a precharge transistor 26, which connects a second power supply line 7-0 for a third sub-pixel which is an analog pixel with a data line 6-0, is provided around the display panel as shown in FIG. 7, and a precharge line 27 is used to control the precharge transistor 26.

That is, no periodic writing operation is performed to third sub-pixels 9-0, which are analog pixels. Therefore, all gate lines 5-0 and all precharge lines 27 are set to Low. Further, each of the precharge transistors 26 provided at one end of the data line 6-0 for each third sub-pixel is turned on, and the data lines 6-0 are continuously precharged with a second power supply potential VDD2. Moreover, the drive transistors 2 of the third sub-pixels 9-0 are turned off. During this precharging operation, the output of the hybrid data driver 15 is retained, or separated from the data lines 6-0 by means of a switch and the like (not shown) provided on the display array 13. With this structure, as it is not necessary for the hybrid data driver 15 to drive the data lines 6-0 while the precharge transistors 26 are turned on, the operation of the analog processor 20 can be halted. Therefore, a further electric power consumption reduction can be achieved. Also, the hybrid data driver 15 can be used to additionally control the precharge lines 27.

The invention has been described in detail with particular reference to certain preferred embodiments thereof, but it will be understood that variations and modifications can be effected within the spirit and scope of the invention.

### PARTS LIST

1 element
2 drive transistor
3 gate transistor
4 storage capacitor
5 gate line
6 data line
7 power supply line
8 cathode electrode
9 sub-pixels
10 unit pixel
11 elements
12 second drive transistors
13 display array
14 gate driver
15 hybrid data driver
16 control circuit
17 frame memory
18 output register
19 digital processor
20 analog processor
21 selector
22 decoder
23 digital buffer
24 da converter
25 analog buffer
26 precharge transistor
27 precharge line
30 data register

1. An organic EL display comprising:
(a) a plurality of digital data lines;
(b) a plurality of analog data lines;
(c) a plurality of pixels arranged in a matrix, each pixel having a digital sub-pixel connected to one of the plurality of digital data lines and an analog sub-pixel connected to one of the plurality of analog data lines; and
(d) a plurality of hybrid data drivers, each connected to the respective digital data line and the respective analog data line, for receiving input data, dividing the input data into digital data and analog data, and supplying digital data to the respective digital data line and analog data to the respective analog data line.

2. The organic EL display of claim 1, wherein each digital sub-pixel includes a static memory for storing the digital data supplied from the connected digital data line.

3. The organic EL display of claim 1, wherein the matrix comprises one or more columns of digital sub-pixels and one or more columns of analog sub-pixels, and wherein each digital data line is provided along a respective column of digital sub-pixels, and each analog data line is provided along a respective column of analog sub-pixels.

4. The organic EL display of claim 1, wherein the hybrid data driver comprises an output register for storing the input data, and a digital processor and an analog processor for processing the input data stored in the output register.

5. The organic EL display of claim 4, wherein the input data is supplied to the output register via a data register, and the data register sequentially supplies the input data for the digital pixel and the input data for the analog pixel to the output register.

6. The organic EL display of claim 1, wherein the input data is digital data having at least one upper bit and at least one lower bit, and wherein each hybrid data driver divides the respective input data by selecting one or more upper bits of input data to be the digital data and by selecting one or more lower bits of input data to be analog data.

7. An organic EL unit pixel comprising a digital sub-pixel and an analog sub-pixel.
